(19) United States
(12) Patent Application Publication
(10) Pub. No.: US 2012/0203390 A1
(43) Pub. Date: Aug. 9, 2012

(54) NETWORK SYSTEM AND METHOD OF CONTROLLING THE SAME

(76) Inventors: Sangsu Lee, Seoul (KR); Baejin Lee, Seoul (KR); Changkwon Park, Seoul (KR); Hoonbong Lee, Seoul (KR)

(21) Appl. No.: 13/501,995

(22) PCT Filed: Oct. 21, 2010
(86) PCT No.: PCT/KR2010/007230

§ 371 Date: Apr. 13, 2012

(30) Foreign Application Priority Data
Oct. 21, 2009 (KR) 10-2009-0100357

(51) Int. Cl. G06F 1/26

(52) U.S. Cl. 700/295

(57) ABSTRACT

A network system comprises: a metering device configured to measure energy supplied from a power supply source by two-way communication with the power supply source; and an EMS (energy management system) connected to the metering device for communicating with the metering device and configured to control an operation of an electric product based on information about the operation of the electric product or information about energy supplied from the power supply source, wherein the EMS is detachably provided to at least one electric product of a plurality of electric products and another electric product of the plurality of electric products.

### TECHNICAL FIELD

The present disclosure relates to a network system and a method of controlling the network system.

### BACKGROUND ART

In general, power for operating electric products such as electric home appliances or office equipment is supplied through a power plant, a power transmission line, and a power distribution line.

Such power is supplied from a central power source, not a distributed power source, so that the power spreads in a radial shape from the center to the periphery, which is supplier-centered rather than consumer-centered. In addition, the supply of the power is analog and electromechanical, and damage due to an accident is manually undone, and related facilities are manually recovered.

The information about electricity charge can be known only through a power exchange, and thus, it is difficult to know the information about electricity charge in real time. In addition, since a pricing system is substantially fixed, it is difficult to provide incentives for consumers by using price variations. To address these limitations and improve the efficiency of energy, research is being actively carried out on a smart grid.

The smart grid means the next generation power system and a management system thereof, which are realized by mixing and combining a modernized power technology and an information communication technology. A typical power grid is vertical and centralized network that is controlled by a supplier, but the smart grid is a horizontal, cooperative, and distributed network that is distributed from a supplier and allows the interaction between suppliers and consumers.

In the smart grid, all electric appliances, power storage devices, and distributed power sources are connected to one another through a network, so that suppliers can interact with consumers. Thus, the smart grid is referred to as an ‘energy Internet’. To realize the smart grid for power consumers such as a house or a building, it is needed that a separate electric product and a network connected to a plurality of electric products communicate with a power supply source through a two-way communication for power information, instead of just receiving power. Also, devices for the two-way communication are needed.

In addition, a method of controlling an electric product is needed, which can analyze an electricity charge in real time when the electric product is used, and can suppress the use of the electric product in a time period when an electricity price is high, thereby saving energy and electricity costs.

### DISCLOSURE OF INVENTION

### Technical Problem

Embodiments provide a network system and a method of controlling the network system, in which power consumptions and operations of electric products are controlled by using an EMS attachable to the electric products so that the electric products can be easily controlled and monitored.

Embodiments also provide a network system and a method of controlling the network system, in which an operational error generated while an electric product is operated is rapidly reported to a service center for analyzing and removing the operational error.

### Solution to Problem

In one embodiment, a network system includes: a metering device configured to measure energy supplied from a power supply source by two-way communication with the power supply source; and an EMS (energy management system) connected to the metering device for communicating with the metering device and configured to control an operation of an electric product based on information about the operation of the electric product or information about energy supplied from the power supply source, wherein the EMS is detachably provided to at least one electric product of a plurality of electric products and another electric product of the plurality of electric products.

In another embodiment, there is provided a method of controlling a network system, the method including: connecting an EMS to an electric product so that the EMS communicates with the electric product; controlling an operation of the electric product based on information about the operation of the electric product and information about energy supplied from a power supply source; disconnecting the EMS from the electric product and connecting the EMS to another electric product; and controlling an operation of the other electric product based on information about the operation of the other electric product and information about energy supplied from the power supply source.

The details of one or more embodiments are set forth in the accompanying drawings and the description below. Other features will be apparent from the description and drawings, and from the claims.

### Advantageous Effects of Invention

According to the embodiments, the power consumption and operation of an electric product can be controlled by using the EMS attachable to a plurality of electric products in a network system. That is, a plurality of electric products can be easily controlled and monitored.

Particularly, since the EMS can be used like a remote controller to control electric products remotely, users can control the electric products easily.

In addition, if the EMS is attached to a particular electric product after settings for the particular electric product are input to the EMS, the electric product can be automatically operated according to the settings. Therefore, settings for a particular electric product can be made with less limitation of places.

In addition, when there is an error while an electric product is operated, the operational error is reported to a personal wireless communication terminal or computer of a user. Therefore, the user may know the operational error immediately.

In addition, a signal, message or data transmitted to a user to report an operational error are unique and distinguishable from those corresponding to other operational errors. Therefore, if the signal, message, or data are sent to a service center, the service center can take action rapidly.

### BRIEF DESCRIPTION OF DRAWINGS

FIG. 1 is a schematic view illustrating a smart grid according to an embodiment.

FIG. 2 is a schematic view illustrating a network system to an embodiment.

FIGS. 3 to 6 are font views illustrating an energy management system (EMS) according to an embodiment.

FIG. 7 is a control block diagram illustrating a network system according to an embodiment.

FIG. 8 is a view illustrating an EMS attached to an electric product according to an embodiment.

FIGS. 9 to 11 are flowcharts for explaining a method of controlling a network system according to an embodiment.

### BEST MODE FOR CARRYING OUT THE INVENTION

Reference will now be made in detail to the embodiments of the present disclosure, examples of which are illustrated in the accompanying drawings.

All terms used herein have the same meanings as general terms understood by those of ordinary skill in the art. If the terms used herein collide with the general terms, the terms used herein take priority over the general terms. While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

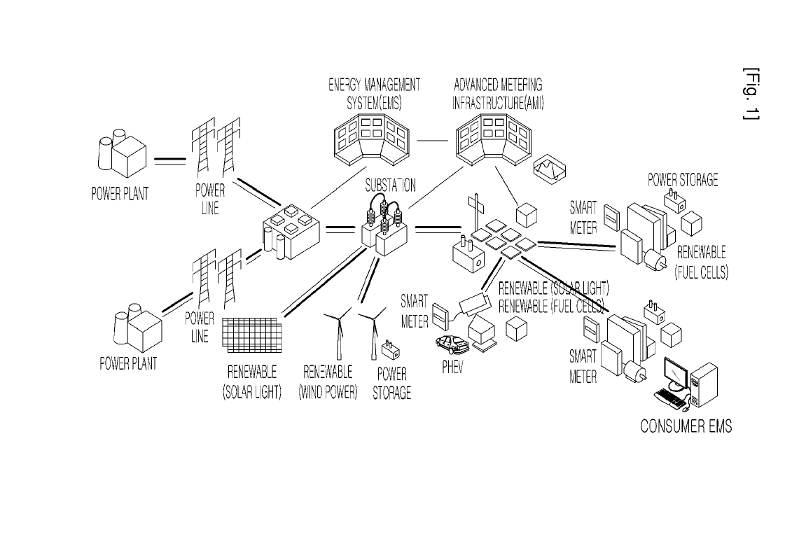

FIG. 1 is a schematic view illustrating a smart grid according to an embodiment.

The smart grid includes a power plant generating electricity by thermal power generation, nuclear power generation, or water power generation; and a solar power plant and a wind power plant that generate electricity from renewalbe energy sources such as solar light and wind power.

The power plant, such as a thermal power plant, a nuclear power plant, and a water power plant, supplies electricity to a sub-control center through a power line, and the sub-control center supplies the electricity to a substation where the electricity is distributed to consumers such as residential customers or offices.

Electricity generated from renewable energy sources is delivered to the substation where the electricity is distributed to consumers. Electricity transmitted from the substation is distributed to consumers such as offices and residential customers through power storages.

Residential customers using a home area network (HAN) may produce electricity by using a solar battery or fuel cells of a plug in hybrid electric vehicle (PHEV) for their own use or selling the remaining electricity.

Energy generated power plants such as mentioned above, renewable energy, and energy generated independently in a house may be collectively referred to as “energy sources.”

In addition, since smart metering devices are provided to consumers such as offices or residential customers, power consumption or electricity bills can be checked in real time, and thus the consumers can take action to reduce power consumption or electricity costs based on the real-time information about power consumption and electricity bills.

Furthermore, since the power plants, the sub-control center, the power storages, and the consumers can communicate with each other (two-way communication), electricity is not transmitted to the consumers unilaterally but generated and distributed to the consumers according to the consumers' situations notified to the power storages, the sub-control center, and the power plants.

In such a smart grid, an energy management system (EMS) plays a pivotal role for real-time power line communication with a consumer, and an advanced metering infrastructure (AMI) plays a pivotal role for real-time power consumption measurement.

The AMI of the smart grid is backbone technology for integrating consumers based on an open architecture. The AMI provides consumers with the ability to use electricity efficiently and power providers with the ability to detect problems on their systems and operate them efficiently.

Herein, the open architecture means a standard for connecting all electric products in a smart grid system regardless of the manufactures of the electric products, unlike in a general communication network. Therefore, the AMI of the smart grid enables consumer-friendly efficiency concepts like “prices to devices.”

That is, real-time price information of an electricity market may be provided through an EMS of each residential customer, and the EMS may control electric products while communicating with the electric products. Thus, a user may see the information displayed on the EMS to check energy information (power information) of each electric product and carry out power information processing such as power consumption limit setting or electricity charge limit setting to save energy and reduce costs.

The EMS may include local EMSs provided in offices or residential customers, and a central EMS configured to process information collected from the local EMSs through two-way communication.

Since real-time communication is possible between providers and consumers in a smart grid for exchanging power information, real-time grid response can be realized, and costs necessary for meeting a peak demand can be reduced.

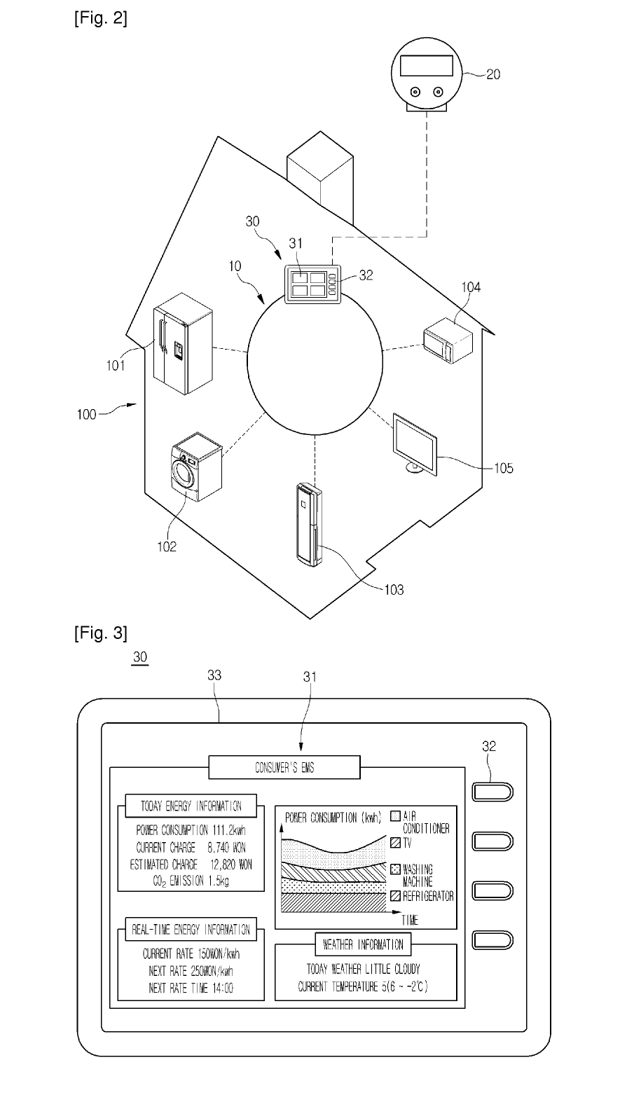

FIG. 2 is a schematic view illustrating a network system to an embodiment. Residential customers are main consumers of electric power, and a power supply network system 10 of a residential customer is shown in FIG. 2.

The power supply network system 10 includes: a metering device (smart meter) 20 which can measure power supply to the residential customer, electricity charge, and a power consumption peak time period in real time; and an EMS 30 connected to the metering device (smart meter) 20 and a plurality of electric devices such as electric products 100 for controlling operations of the electric products 100.

The EMS 30 may be provided in the form of a terminal, which includes a screen 31 to display the current power consumption state and external environments (temperature, humidity) and an input unit 32 to receive user's manipulations.

The EMS 30 is connected to the electric products 100 such as a refrigerator 101, a washing or drying machine 102, an air conditioner 103, a TV 105, and a cooking device 104 through an in-house network for two-way communication.

In-house communication may be performed by wireless or power line communication (PLC). Furthermore, the electric products 100 may be connected to each other for communicating with each other.

FIG. 3 is a view illustrating an EMS 30 according to an embodiment. The EMS 30 may be a terminal including a touch panel 33.

A screen 31 may be displayed on the touch panel 33 to provide: today energy information about a current electricity consumption amount, a current electricity charge, an electricity charge estimated based on an accumulated consumption history, and a carbon dioxide emission amount; real-time energy information about an electricity rate of a current time period, an electricity rate of a next time period, and a time at which the electricity rate varies; and weather information.

In addition, a graph may be displayed on the screen 31 of the touch panel 33 to show power consumption amounts of electric products with respect to time. Buttons 32 are provided at a side of the screen 31 so that a user can input settings to the electric products using the buttons 32.

A user can set a power consumption limit or an electricity charge limit by using the buttons 32, and the EMS 30 may control the electric products according to the user's setting.

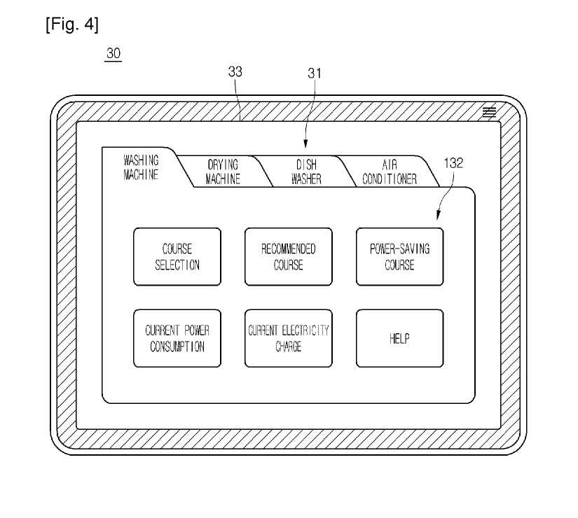

FIG. 4 is a view illustrating a method of selecting operations of the electric products.

The screen 31 may be an upper direction for the electric products, and selection items 132 such as operation modes, power amounts, and electricity charges may be shown in the form of lower directions or files.

For example, after selecting a washing machine, a user can select a selection item 132 such as course, recommended course, and power-saving course. In addition, the user can select another selection item 132 such as current power consumption, current electricity charge, and help. The selection items 132 are provided in the form of icons so that a user can touch one of the selection items 132 to see desired contents.

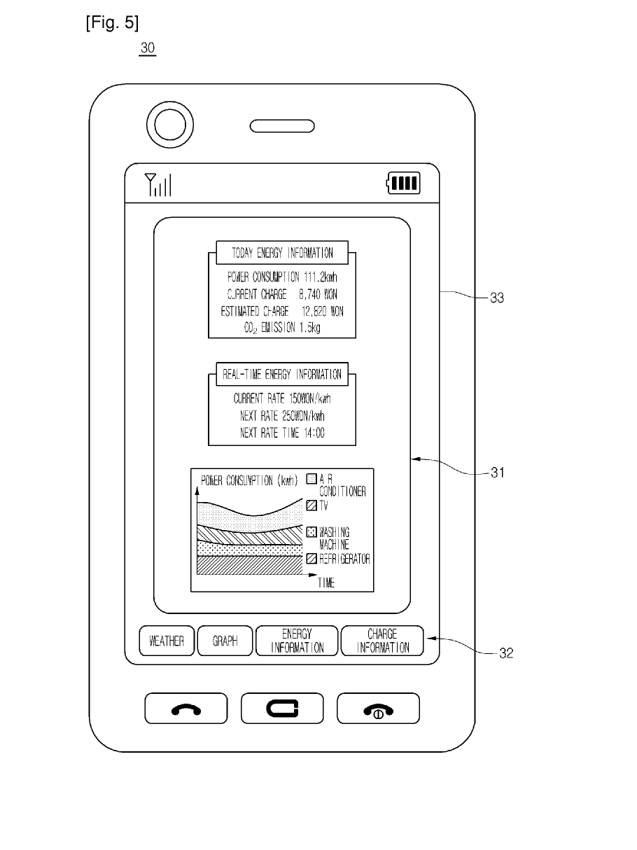

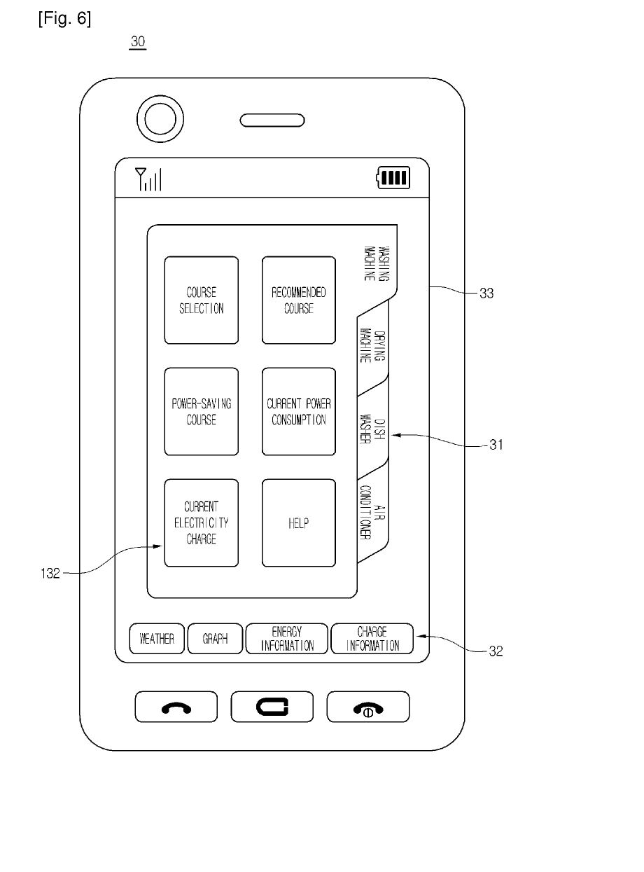

FIGS. 5 and 6 illustrate the case where the EMS 30 is provided in the form of a wireless communication terminal such as a cellular phone or personal digital assistant (PDA). A touch panel 32 provides a screen 31 to display information, touch buttons 32, and selection items 132.

The EMS 30 shown in FIGS. 3 and 4 may be an in-house energy management terminal. The EMS 30 shown in FIGS. 5 and 6 is a wireless communication terminal having an energy management function as well as original functions of a wireless communication terminal such as video telephony, voice telephony, and short message service (SMS). The EMS 30 shown in FIGS. 5 and 6 is substantially the same as the EMS 30 shown in FIGS. 3 and 4 except for the external shape. Thus, a detailed description thereof will not be repeated.

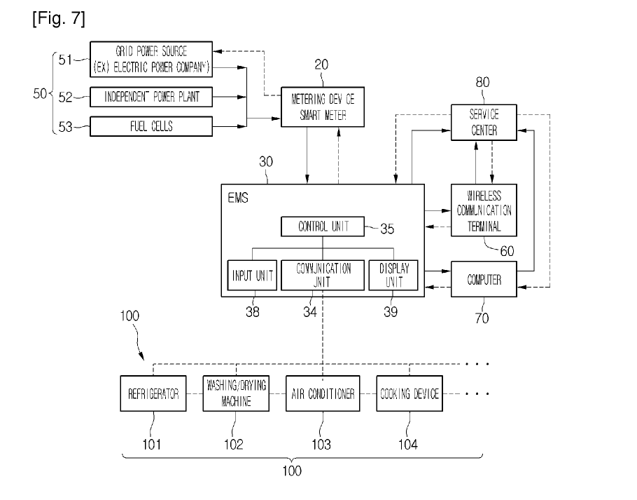

FIG. 7 is a control block diagram illustrating a power supply source and a network system configured to supply power to in-house electric products in a smart grid.

The power supply source may be an electric power company 51 having a general power generation equipment (e.g., a thermal power plant, a nuclear power plant, or water power plant) or a power plant using a renewable energy source (e.g., solar light, wind power, or geothermal power). In addition, the power supply source may further include an independent power plant 52 of a residential customer, and fuel cells 53 of a fuel cell vehicle or a residential customer. The power supply source may be connected to a metering device (smart meter) 20.

The EMS 30 includes a control unit 35, an input unit 38, a communication unit 34, and a display unit 39. The communication unit 34 communicates with in-house electric products 100 for receiving and transmitting power and operation information of the electric products 100.

The control unit 35 checks setting information input by a user through the input unit 38, accumulated history information about operations and power consumptions of the electric products 100, and real-time information about the supply amount of electricity. Then, the control unit 35 processes the information in real time to control operations of the electric products 100 and power to the electric products 100.

The EMS 30 may communicate with a personal wireless communication terminal 60 or a computer 70.

If the EMS 30 detects an operation error such as malfunction of the electric products 100 or an abnormal power consumption state, the EMS 30 reports it to the wireless communication terminal 60 or the computer 70. Then, a user can determine whether the electric products 100 are normal or abnormal by contacting a service center 80 through the wireless communication terminal 60 or the computer 70 and informing the service center 80 of the operation error information received from the EMS 30. If the EMS 30 is a wireless communication terminal such as a PDA, a user can contact the service center 80 directly through the EMS 30.

The wireless communication terminal 60 or the computer 70 may be called “error information receive device.”

Transmission of voice signals, messages, or data among the EMS 30, the wireless communication terminal 60, the computer 70, and the service center 80, and corresponding responses will be described later.

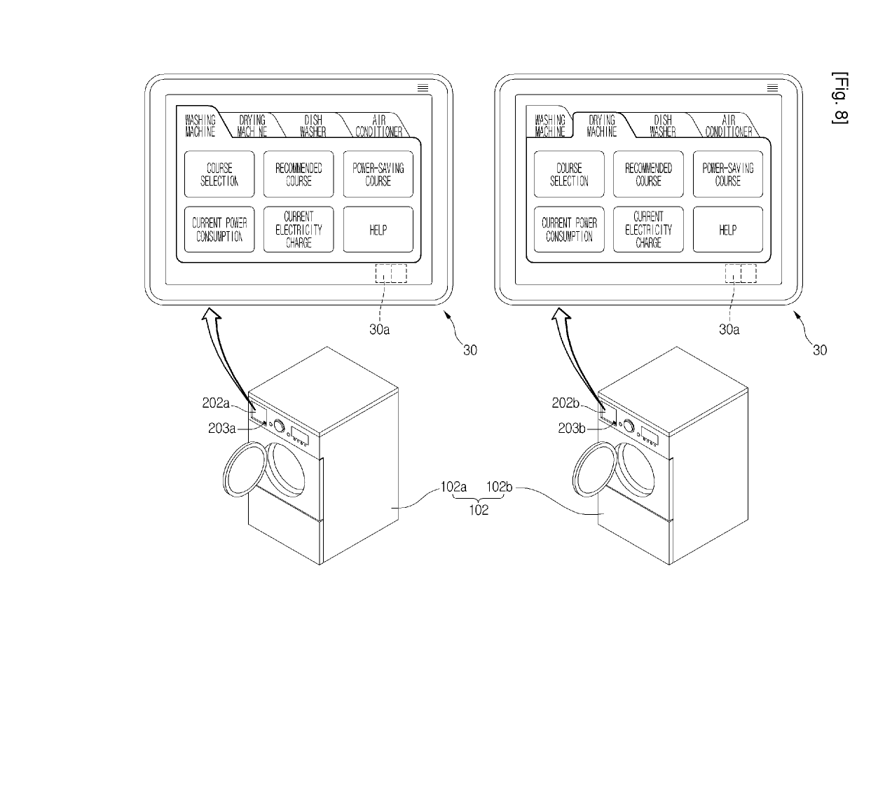

FIG. 8 is a view illustrating the EMS 30 attached to an electric product according to an embodiment.

The EMS 30 may be compatible with a washing machine 102a and a drying machine 102b. In addition, the EMS 30 may be compatible with other electric products such as an air conditioner and a cooking device.

Mounting parts 202a and 202b are provided respectively at the washing machine 102a and the drying machine 102b so that the EMS 30 can be attached. Contact terminals 203a and 203b are provided at the mounting parts 202a and 202b for making contact with the EMS 30.

When the EMS 30 is attached to the washing machine 102a or the drying machine 102b, a contact terminal 30a of the EMS 30 makes contact with the contact terminal 203a or 203b of the washing machine 102a or the drying machine 102b so that the EMS 30 can communicate with the washing machine 102a or the drying machine 102b. The contact terminals 203a and 203b will also be referred to as first contact terminals, and the contact terminal 30a will also be referred to as a second contact terminal.

Alternatively, the EMS 30 may communication with the washing machine 102a or the drying machine 102b by wireless instead of a contact communication method. In this case, the EMS 30 may be used as a remote controller.

If the EMS 30 is attached to the mounting part 202a of the washing machine 102a, an interface for controlling the washing machine 102a is displayed on the display unit 39 of the EMS 30. On the other hand, if the EMS 30 is attached to the mounting part 202b of the drying machine 102b, an interface for controlling the drying machine 102b is displayed on the display unit 39 of the EMS 30.

In this way, when the EMS 30 is attached to a particular electric product, an interface for inputting user's settings to the particular electric product is displayed on the EMS 30. Therefore, a user can input settings to the particular electric product without having to select the particular electric product from a plurality of electric products displayed on the EMS 30.

If a user attaches the EMS 30 to a particular electric product after setting an operation mode for the particular electric product, an interface corresponding to the particular electric product is displayed on the EMS 30. Then, the particular electric product may be operated in the preset operation mode.

The above-described structure of the mounting parts 202a and 202b and the contact terminals 203a and 203b may also be applied to other electric products such as a refrigerator, an air conditioner, and a cooking device, as well as the washing machine 102a and the drying machine 102b.

The EMS 30 may store operational information of one of a plurality of electric products or process result information of the electric product. Then, when the EMS 30 is attached to another electric product, the EMS 30 may provide the information to the other electric product if the other electric product requires the information.

For example, in a state where operational information of the washing machine 102a or process result information such as the kind and level of spin-drying of laundry processed by the washing machine 102a is stored in the EMS 30, if the EMS 30 is attached to the drying machine 102b, the information may be transmitted to the drying machine 102b.

Then, a drying time, a drying temperature, or necessary electric power of the drying machine 102b may be adjusted based on the information. Such flows of information are not limited between a washing machine and a drying machine but can be applied among an air conditioner, a refrigerator, and a cooking machine.

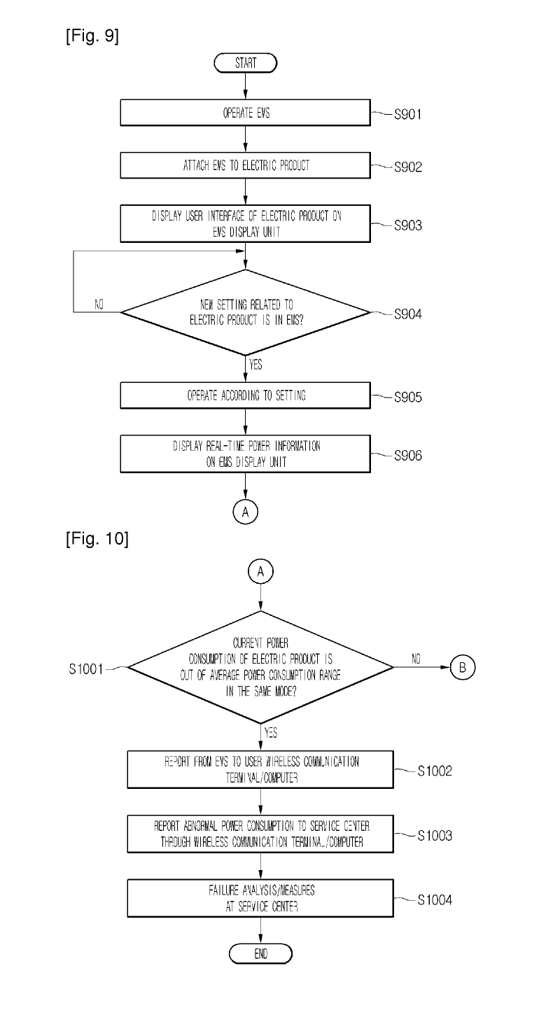

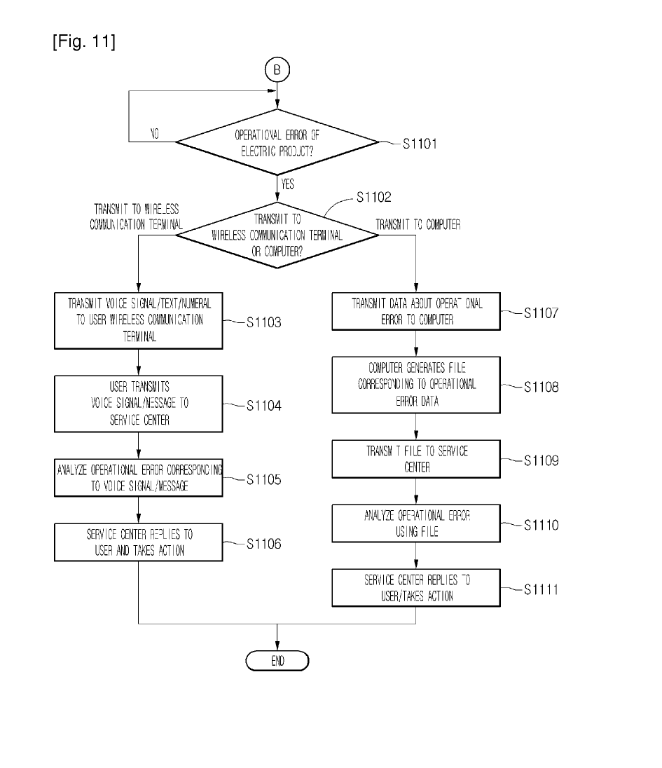

FIGS. 9 to 11 are flowcharts for explaining a method of controlling a network system according to an embodiment.

Referring to FIG. 9, if a user operates an EMS (S901) and attaches the EMS to a particular electric product (S902), a display unit of the EMS displays a user interface of the particular electric product (S903).

In this state, it is determined whether a new setting related to an operation of the particular electric product is in the EMS (S904). If it is determined that a new setting is in the EMS, the particular electric product is operated according to the setting (S905). Then, real-time power information such as power consumption state and electricity charge is displayed on the display unit of the EMS (S906).

Then, as shown in FIG. 10, while the electric product is operated according to the setting in a particular operation mode, it is determined whether the current power consumption amount of the electric product gets out of an average power consumption amount range of the same mode (S1001).

If it is determined that the current power consumption amount of the electric product gets out of the average power consumption amount range of the same mode, it may be determined that the electric product is abnormally operated. Then, the EMS reports the abnormal operation of the electric product to a user's wireless communication terminal or computer (S1002). At this time, a voice signal, a numeral signal, or a text message may be transmitted to the wireless communication terminal, and data may be transmitted to the computer.

The wireless communication terminal may be provided separately from the EMS or included in the EMS.

To analyze the abnormal operation correctly, the user may transmit the voice signal, the text message, or the data to a service center to inform of abnormal power consumption (S1003). Then, the service center may analyze the received information and take action (S1004).

In operation S1001, if it is determined that the current power consumption amount of the electric product does not get out of the average power consumption amount range of the same mode, it is determined whether there is an operational error while the electric product is operated (S1101). If it is determined that there is an operational error, it is determined whether the operational error is reported to the wireless communication terminal or the computer (S1102). It may be predetermined whether the operational error is reported to the wireless communication terminal or the computer.

If the user has set the wireless communication terminal as an error information receiver, the EMS sends a voice signal, a text message, a numeral message, or a combination thereof to the wireless communication terminal (S1103).

The EMS may send a voice signal or a message corresponding to the operational error to the error information receiver set by the user so that the voice signal or message received from the EMS can be sent as it is to a service center for analyzing the operational error using the voice signal or message.

The voice signal or the message corresponds to the operational error and may be composed of a unique voice signal or a unique combination of numerals and characters so that it can be distinguished from other voice signals or messages corresponding to other operation errors.

Thus, the user can send the voice signal or message to service center without having to modifying or editing it (S1104).

Then, the service center receives the voice signal or message and analyzes it (S1105).

Next, the service center replies to the voice signal or message and takes action to remove the operational error (S1106).

In case where the operational error is reported to the computer connected to internet, the EMS transmits data about the operational error to the computer (S1107). Then, the computer generates a file corresponding to the data (S1108). The file corresponds to the operational error and may be composed of unique contents distinguishable from other files corresponding to other operational errors. The user may send the file to the service center (S1109).

Then, the service center receives the file and analyzes it (S1110). Next, the service center replies to the file and takes action to remove the operational error (S1111).

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

According to the network system of the embodiment, the power consumption and operation of an electric product can be controlled by using the EMS attachable to a plurality of electric products in a network system. That is, since a plurality of electric products can be easily controlled and monitored, the industrial applicability of the network system of the embodiments is high.

1. A network system comprising:
a metering device configured to measure energy supplied from a power supply source by two-way communication with the power supply source; and
an EMS (energy management system) connected to the metering device for communicating with the metering device and configured to control an operation of an electric product based on information about the operation of the electric product or information about energy supplied from the power supply source,
wherein the EMS is detachably provided to at least one electric product of a plurality of electric products and another electric product of the plurality of electric products.

2. The network system according to claim 1, wherein the EMS is compatible with the plurality of electric products.

3. The network system according to claim 1, wherein the EMS is configured to communicate with each of the plurality of electric products so that the plurality of electric products are operated in a control mode set in the EMS.

4. The network system according to claim 3, wherein if the EMS is connected to the at least one electric product, the EMS recognizes operation information of the at least one electric product.

5. The network system according to claim 4, wherein if the EMS is disconnected form the at least one electric product and is connected to the other electric product, the EMS recognizes operation information of the other electric product.

6. The network system according to claim 5, wherein the operation information of the at least one electric product is transmitted to the other electric product by the EMS.

7. The network system according to claim 1, wherein the EMS is connected to the at least one electric product by wire or wireless.

8. The network system according to claim 7, further comprising:
a first contact terminal provided at the at least one electric product; and
a second contact terminal provided at the EMS to couple with the first contact terminal.

9. The network system according to claim 1, further comprising an error information receiver configured to receive operational error information of the at least one electric product or the other electric product from the EMS.

10. The network system according to claim 9, wherein the error information receiver comprises a wireless communication terminal or a computer.

11. The network system according to claim 9, wherein the operational error information comprises at least one of characters, numerals, combinations of the characters and numerals, voice signals, and data.

12. The network system according to claim 9, wherein the operational error information of the at least one electric product corresponds to one of a plurality of operational errors and is composed of a unique message distinguishable from information corresponding to the other operational errors.

13. The network system according to claim 1, further comprising a service center configured to receive error information of the al least one electric product or the other electric product and process the received error information.

14. The network system according to claim 1, wherein when the at least one electric product or the other electric product consumes power more than a preset limit, the EMS displays the excessive power consumption state.

15. A method of controlling a network system, the method comprising:
connecting an EMS to an electric product so that the EMS communicates with the electric product;
controlling an operation of the electric product based on information about the operation of the electric product and information about energy supplied from a power supply source;
disconnecting the EMS from the electric product and connecting the EMS to another electric product; and
controlling an operation of the other electric product based on information about the operation of the other electric product and information about energy supplied from the power supply source.

16. The method according to claim 15, further comprising:
in a state where the EMS is connected to the electric product, determining whether the EMS has a new setting related to an operation of the electric product;
if it is determined that the EMS has a new setting related to an operation of the electric product, operating the electric product according to the new setting.

17. The method according to claim 15, further comprising displaying power information of the electric product when the electric product is operated.

18. The method according to claim 15, further comprising determining whether an amount of energy consumed in a predetermined operation mode of the electric product or the other electric product is greater than an average energy consumption range in the predetermined operation mode.

19. The method according to claim 18, wherein if the amount of energy consumed in the predetermined operation mode of the electric product or the other electric product is greater than the average energy consumption range in the predetermined operation mode, the method further comprises transmitting information about the excessive amount of energy consumption to a service center.

20. The method according to claim 19, wherein the information about the excessive amount of energy consumption is transmitted to the service center through a wireless communication terminal or a computer.

21. The method according to claim 15, further comprising:
determining whether there is an operational error of the electric product or the other electric product; and
if it is determined that there is an operational error, transmitting information about the operational error to a service center.

22. The method according to claim 21, wherein the information about the operational error is letter information, numeral information, a combination of the letter information and the numeral information, a voice signal, or computer-transmittable data.
